(19) United States
(12) Patent Application Publication
(10) Pub. No.: US 2022/0134458 A1
(43) Pub. Date: May 5, 2022

(54) GEAR PROCESSING APPARATUS AND METHOD

(71) Applicant: NATIONAL CENTRAL UNIVERSITY, Taoyuan City (TW)

(72) Inventor: Yu-Ren WU, Taoyuan City (TW)

(21) Appl. No.: 17/513,195

(22) Filed: Oct. 28, 2021

(30) Foreign Application Priority Data
Oct. 30, 2020 (TW) 109137836

(51) Int. Cl. B23F 5/04; B23F 21/02

(52) U.S. Cl. CPC B23F 5/04; B23F 21/026

(57) ABSTRACT

The presented disclosure provides a gear processing apparatus, including a base, a driving unit, a bearing unit, a grinding assembly and a control unit. The driving unit, the bearing unit and the grinding assembly are arranged on the base. The bearing unit is used to carry the gear and can be activated by the driving unit to perform plural first corresponding axial movements relative to the bearing unit. The grinding assembly includes a grinding member. The grinding assembly can be activated by the driving unit to perform plural second corresponding axial movements relative to the bearing unit to contact the tooth surface of the gear by the grinding member. The control unit is used to control the driving module to apply additional movement to at least one of the plural first corresponding axial directions or/and at least one of the plural second corresponding axial directions during the grinding process to change the grinding directions of the tooth surface of the gear generated by the grinding member.

### FIELD OF THE INVENTION

The present disclosure relates to a gear processing technology and, more particularly, to a gear processing device and method that can change the grinding texture and roughness of the tooth surface of the gear.

### BACKGROUND OF THE INVENTION

Gears are common transmission components, and the gears can be made of different materials according to different usage requirements. For example, when the gears are used in vehicle components or high-precision measuring equipment, these gears are mostly made of hard metals or alloys in order to maintain stability and durability of operation. For the tooth surface of this kind of gears, grinding wheels are usually used for grinding to shape the tooth surface of the gear.

However, during the process of the grinding wheel processing, much fine grinding texture that cannot be seen by the naked eye are formed on the tooth surface of the gear. Since the grinding wheel always regularly grinds the tooth surface in a single direction, the grinding texture is correspondingly roughly along the tooth length direction and parallel to each other. The grind texture makes the gear easy to generate noise with a specific frequency during transmission, and is not conducive to the formation of lubricating oil film in the meshing area, which will affect the operation efficiency and quality of the gear. Therefore, how to reduce the possibility of noise generation by improving the adverse effects caused by the fine grinding texture formed on the tooth surface of the gear is indeed a topic worthy of research.

### SUMMARY OF THE INVENTION

The present disclosure provides a gear processing device that can change the grinding texture and roughness of the tooth surface of the gear.

To achieve the above-mentioned object, the gear processing device of the present disclosure comprises a base, a driving unit, a bearing unit, a grinding assembly, and a control unit. The driving unit, the bearing unit and the grinding assembly are arranged on the base. The bearing unit is used for bearing the gear, and the bearing unit is driven by the driving unit to perform a motion with a plurality of first corresponding axial directions relative to the base. The grinding assembly includes a grinding element, and the grinding assembly is driven by the driving unit to perform a motion with a plurality of second corresponding axial directions relative to the bearing unit, so that the grinding element contacts the tooth surface of the gear. The control unit is electrically connected to the driving unit, wherein the control unit is used to control the driving unit to apply an additional motion for at least one of the plurality of first corresponding axial directions, or/and at least one of the plurality of second corresponding axial directions during a grinding process to change direction of the grinding texture produced by the grinding element on the tooth surface of the gear.

In one of the embodiments of the present disclosure, the additional motion is a one-time motion or a continuous motion.

In one of the embodiments of the present disclosure, an additional installation angle of the gear is adjusted by the one-time motion, so that a center of a contact area of the grinding element and the tooth surface of the gear is not on a plane formed by an axis of the grinding element, and a rotation axis applied the one-time motion.

In one of the embodiments of the present disclosure, the continuous motion is a wave motion.

In one of the embodiments of the present disclosure, the wave motion is selected from at least one or a combination of the following groups: a sine wave motion, a square wave motion, a triangle wave motion, or a sawtooth wave motion.

In one of the embodiments of the present disclosure, the control unit controls the driving unit to apply the different wave motions to at least two of the plurality of second corresponding axial directions during the grinding process.

In one of the embodiments of the present disclosure, the control unit controls the driving unit to apply the same wave motions with different amplitudes or frequencies to at least two of the plurality of second corresponding axial directions during the grinding process.

In one of the embodiments of the present disclosure, the grinding element is a grinding wheel.

In one of the embodiments of the present disclosure, the plurality of first corresponding axial directions or the plurality of second corresponding axial directions are at least two selected from the following groups: three moving axes and three rotating axes corresponding to six degrees of freedom.

The present disclosure further provides a gear processing method for performing a surface processing on a tooth surface of a gear. The gear processing method comprises: providing a gear processing device, wherein the gear processing device includes a driving unit, a bearing unit that bears the gear, and a grinding assembly includes a grinding element; and applying the driving unit to drive the bearing unit to perform a motion of a plurality of first corresponding axial directions relative to the base or/and to drive the grinding assembly to perform a motion of a plurality of second corresponding axial directions relative to the bearing unit, so as to make the grinding element to contact the tooth surface of the gear. Wherein the driving unit applies an additional motion to at least one of the plurality of first corresponding axial directions or/and at least one of the plurality of second corresponding axial directions during a grinding process, so as to change the direction of the grinding texture produced by the grinding element on the tooth surface of the gear.

Accordingly, the gear processing device of the present disclosure can change the complex grinding texture formed on the tooth surface of the gear to produce interlaced and non-parallel texture, and control the surface roughness to avoid excitation of noises with specific frequencies when the gear meshes and achieve the effect of noise reduction.

### BRIEF DESCRIPTION OF THE DRAWINGS

FIG. 1 is a block diagram of the gear processing device of the present disclosure;

FIG. 2 is a schematic diagram of the structure of the gear processing device of the present disclosure;

FIG. 3 is a schematic diagram of the additional motion performed by the gear processing device of the present disclosure on the rotating axis corresponding to the bearing unit;

FIG. 4 is a schematic diagram of the change of the contact area between the grinding element and the tooth surface of the gear before and after the additional motion shown in FIG. 3 is performed;

FIG. 5 is a schematic diagram of a comparison of the grinding results of the tooth surface of the gear of the control group A1 and the experimental group B1 of the gear processing device of the present disclosure;

FIG. 6 is a schematic diagram of the additional motion performed by the grinding unit of the gear processing device of the present disclosure;

FIG. 7 is a schematic diagram of a comparison of the grinding results of the tooth surface of the gear of the control group A2 and the experimental groups B2˜E2 of the gear processing device of the present disclosure; and

FIG. 8 is a flow chart of the gear processing method of the present disclosure.

### DETAILED DESCRIPTION OF THE PREFERRED EMBODIMENTS

In order to make the description of the present disclosure more detailed and complete, please refer to the attached drawings and the various embodiments described below. The elements in the drawings are not drawn to scale and are provided only to illustrate the present disclosure. The following practical details are described in order to provide a comprehensive understanding of this disclosure. However, those of ordinary skill in the relevant fields should understand that this disclosure can be implemented without one or more practical details. Therefore, these details should not be used to limit this disclosure. Since various aspects and embodiments are only illustrative and non-limiting, after reading this specification, those with ordinary knowledge may have other aspects and embodiments without departing from the scope of the present disclosure. According to the following detailed description and patent application scope, the features and advantages of these embodiments will be more prominent.

In present disclosure, “a” or “an” is used to describe the units, elements, and components described herein. This is done for convenience of description only and providing a general meaning to the scope of the present disclosure. Therefore, unless clearly stated otherwise, the description should be understood to include one, at least one, and the singular can also include plural.

In this specification, the terms “first” or “second” and other similar ordinal numbers are mainly used to distinguish or refer to the same or similar elements or structures, and do not necessarily imply that these elements or structures are in space or chronological order. It should be understood that in certain situations or configurations, ordinal numbers can be used interchangeably without affecting the implementation of this creation.

In this disclosure, the terms “including”, “having”, “containing” or any other similar terms are intended to encompass non-exclusive inclusive. For example, a component, structure, article, or device that contains a plurality element is not limited to such elements as listed herein but may include those not specifically listed but which are typically inherent to the component, structure, article, or device. In addition, the term “or” means an inclusive “or” rather than an exclusive “or” unless clearly stated to the contrary.

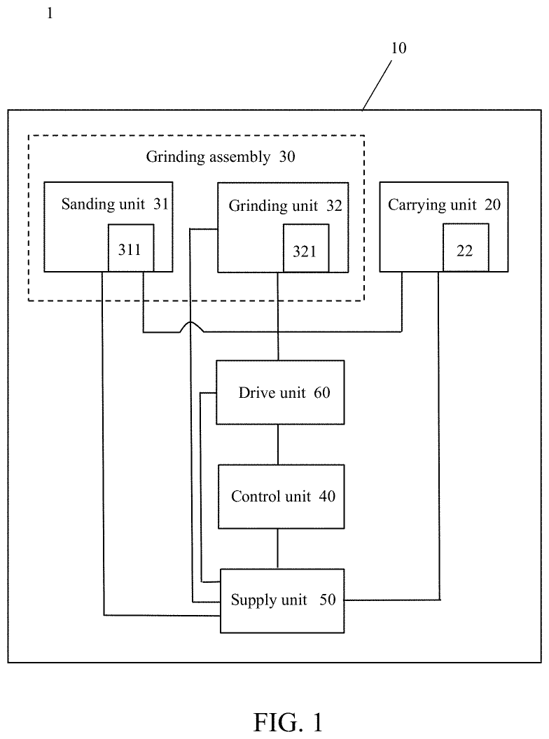

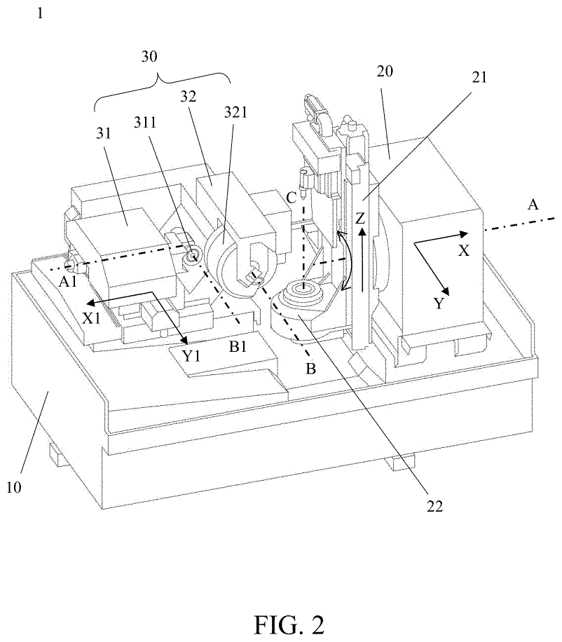

The gear processing device of the present disclosure is configured to perform surface grinding processing on the tooth surface of the gear to reduce the surface roughness of the tooth surface of the gear. Please refer to FIG. 1 and FIG. 2 collectively, in which FIG. 1 is a block diagram of the gear processing device of the present disclosure, and FIG. 2 is a schematic diagram of the structure of the gear processing device of the present disclosure. As shown in FIGS. 1 and 2, the gear processing device 1 of the present disclosure includes a base 10, a driving unit 60, a bearing unit 20, a grinding assembly 30 and a control unit 40. The base 10 is the basic structure of the gear processing device 1 of the present disclosure, and is provided for the installation of various functional units or components.

The driving unit 60 is arranged on the base 10. The driving unit 60 is connected to the bearing unit 20 and the grinding assembly 30, and the driving unit 60 is used to drive the bearing unit 20 or/and the grinding assembly 30 to perform multiple axial movements, so as to facilitate the gear processing by the grinding assembly 30. The driving unit 60 may be a motor, an electric motor, or other devices capable of driving parts to move or/and rotate.

The bearing unit 20 is arranged on the base 10. The bearing unit 20 is used to carry the gear to be processed. The bearing unit 20 includes a bearing portion 22. The driving unit 60 can drive the bearing portion 22 to perform a motion with a plurality of first corresponding axial directions relative to the base 10 to cooperate with the grinding assembly 30 to process the gear. The bearing portion 22 is used to place and fix the gear to be processed. In an embodiment of the present disclosure, the driving unit 60 can drive the bearing portion 22 to perform a single or multiple axial directional motion, for example, perform linear motions along the X axis and Y axis in FIG. 2 or rotate along the A axis to change relatively the processing position of the gear. The driving unit 60 can also drive the bearing portion 22 to perform a linear motion along the Z axis. The driving unit 60 can further drive the bearing portion 22 to perform a rotational motion along a rotation axis C to synchronously drive the gear to rotate. That is to say, in this embodiment, the aforementioned plurality of first corresponding axial directions are selected from at least two or a combination of the following groups: three moving axes and three rotating axes corresponding to six degrees of freedom, but the present disclosure is not limited thereto.

The grinding assembly 30 is arranged on the base 10. The grinding assembly 30 is used to perform grinding operations on the gear to be processed. The driving unit 60 can drive the grinding assembly 30 to perform a motion of a plurality of second corresponding axial directions relative to the bearing unit 20 to grind the gear. In the present disclosure, the grinding assembly 30 includes a sanding unit 31 and a grinding unit 32, wherein the sanding unit 31 includes a sanding element 311, and the grinding unit 32 includes a grinding element 321. The sanding unit 31 is used to perform sand dressing operations on the grinding element 321 of the grinding unit 32. The grinding unit 32 uses the grinding element 321 to contact the tooth surface of the gear to grind the gear to be processed. That is to say, in this embodiment, the aforementioned plurality of second corresponding axial directions are selected from at least two or a combination of the following groups: three moving axes and three rotating axes corresponding to six degrees of freedom, but the present disclosure is not limited to this.

For example, the driving unit 60 can drive the sanding unit 31 to perform a single or multiple axial motion, such as linear motions along the X1 axis and Y1 axis in FIG. 2 or rotate along the A1 axis to change relatively the processing position of the grinding element 321. The driving unit 60 can also drive the sanding element 311 to perform a rotational motion along a rotation axis B1 to synchronously drive the sanding element 311 to rotate. The driving unit 60 can drive the grinding element 321 to perform a rotational motion along a rotation axis B to synchronously drive the grinding element 321 to rotate. As shown in FIG. 2, the motion equations of each axis in the gear processing device of the present disclosure are as follows:

$$\{ \begin{matrix}{ψ}_{A} = {γ}_{wg} \\ {F}_{X 1} ( {ψ}_{w} ) = {r}_{A} + {r}_{w} \\ {F}_{r 1} ( {ψ}_{w} ) = \pm {p}_{w} \frac{{ψ}_{w}}{2 π} \\ {ψ}_{A 1} ( {ψ}_{w} ) = {γ}_{dw} \\ {F}_{X} ( {F}_{Z} ) = {r}_{w} + {r}_{g} + {xm}_{n} \\ {F}_{X} ( {F}_{Z} ) = \frac{{b}_{w}}{{b}_{g}} {F}_{Z} \\ {ψ}_{C} ( {ψ}_{B} . {F}_{Z} ) = \pm {ψ}_{B} \frac{{T}_{w}}{{T}_{g}} \frac{{b}_{w}}{{b}_{g}} \frac{{F}_{Z}}{{p}_{w}} + \frac{tan {β}_{g} {F}_{Z}}{{r}_{g}}\end{matrix}$$

Wherein ψ represents the angle of rotation of the rotating axis, F represents the amount of movement of the sliding axis, and the subscript represents the code of the corresponding axis in FIG. 2. r_{dg} presents the theoretical axis angle of the sanding element 311 and the grinding element 321, r_{wg} represents the theoretical axis angle of the grinding element 321 and the gear, and r_{d}, r_{w} and r_{g} are the pitch radius of the sanding element 311, the grinding element 321 and the gear, respectively. p_{w} is the wheel guide, x is the shifted coefficient, inn is the normal modulus, b_{w} is the length of the grinding element 321, b_{g} is the tooth width of the gear, and T_{w} and T_{g} is the number of teeth of the grinding element 321 and the gear, respectively, β_{g} is the pitch helix angle of the gear.

In an embodiment of the present disclosure, the grinding element 321 may be a grinding wheel. The following description takes a worm grinding wheel as an example, but the present disclosure is not limited to this. The axis angle of the worm grinding wheel and the gear is the addition of the wheel guide angle and the gear helix angle. The sign depends on the respective direction of rotation. During the grinding process, the grinding structure of the worm grinding wheel and the tooth surface of the gear mesh with each other to facilitate execution grinding operations. However, in response to different needs, the axis angle of the worm grinding wheel and the gear can also be changed.

The control unit 40 is electrically connected to the driving unit 60. In an embodiment of the present disclosure, the control unit 40 is also arranged on the base 10, so that the gear processing device 1 of the present disclosure can form an integrated design, but the present disclosure is not limited to this. For example, the control unit 40 can be separated from the base 10 in structural, and be electrically connected to the driving unit 60 only by wires. The control unit 40 can be a control chip, a processor or a computer host, etc., for transmitting instructions to control the driving unit 60 to drive the bearing unit 20 or/and the grinding assembly 30 so as to drive the grinding element 321 to perform the grinding operation on the gear to be processed.

In addition, in an embodiment of the present disclosure, the gear processing device 1 of the present disclosure further includes a power supply unit 50, which is electrically connected to the driving unit 60, the bearing unit 20, the grinding assembly 30, and the control unit 40. The power supply unit 50 can be connected to an external power supply to provide the power required by the aforementioned units.

In addition to using the driving unit 60 to drive the bearing portion 22 and the grinding element 321 to move relative to each other to position, and to drive the grinding element 321 and the gear to be processed to rotate respectively, during the grinding process, the gear processing device 1 of the present disclosure mainly uses the control unit 40 to control the driving unit 60 to apply an additional motion to at least one of the plurality of first corresponding axial directions (corresponding to the bearing unit 20) or/and at least one of the plurality of second corresponding axial directions (corresponding to the grinding assembly 30), so that the bearing portion 22 or/and the grinding element 321 will be driven by the driving unit 60, and the grinding operation is performed in the state where the additional motion is executed or after the additional movement has been executed.

In an embodiment of the present disclosure, the additional motion applied by the driving unit 60 to any corresponding axial direction may be a one-time motion or a continuous motion. The one-time motion here is defined relative to the continuous motion. The one-time motion is defined as moving an object from a first position to a second position, so that the object produces a one-time spatial position change. The continuous motion is defined as the repeated motion of an object between different positions, so that the object continuously changes its spatial position.

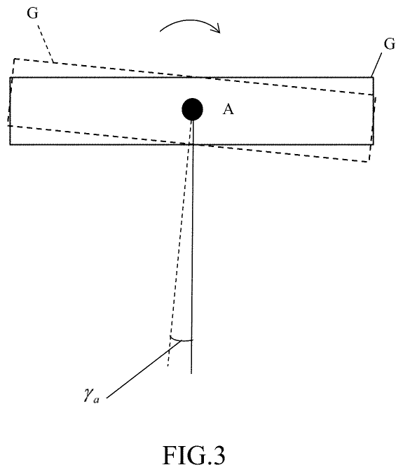

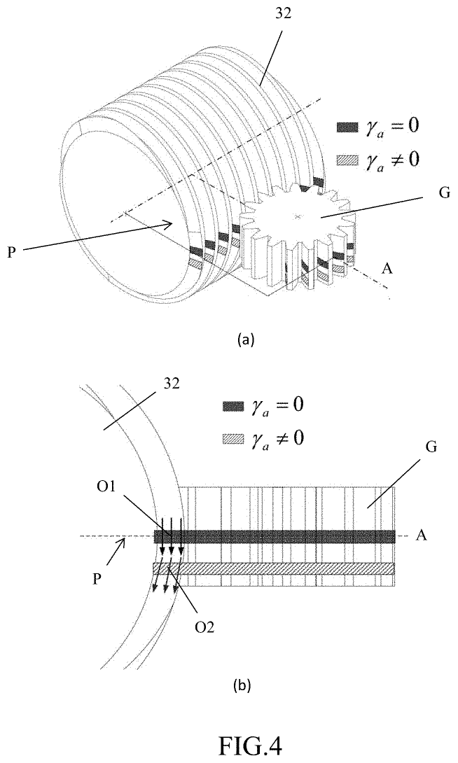

Please refer to FIGS. 1 to 4 together, in which FIG. 3 is a schematic diagram of the additional motion performed by the gear processing device of the present disclosure on the rotating axis corresponding to the bearing unit, and FIG. 4 is a schematic diagram of the change of the contact area between the grinding element and the tooth surface of the gear before and after the additional motion shown in FIG. 3 is performed. In an embodiment of the present disclosure, the aforementioned additional motion is a one-time axial offset motion, which is only applied to the rotation axis of the plurality of first corresponding axial directions of the bearing unit 20. As shown in FIGS. 2 and 3, in this embodiment, the bearing unit 20 further includes a moving part 21. One end of the moving part 21 is connected to the bearing portion 22, and the moving part 21 can be driven by the driving unit 60 to rotate relative to the base 10 based on the rotation axis A. Here, the rotation axis A is a horizontal axis through the rotation axis of the grinding unit 321 and the rotation axis of the gear G at the same time. After the moving part 21 rotates based on the rotation axis A, the moving part 21 can drive the bearing portion 22 and the placed gear G to rotate based on an axial direction R, thereby changing the installation angle of the gear G. In the standard motion, the installation angle is equivalent to the axis angle of the grinding unit 321 and the gear G. In the present disclosure, an additional installation angle can be added through the foregoing operation to change the original relationship between the grinding unit 321 and the gear G.

As shown in FIGS. 3 and 4, generally during the grinding process, the center O1 of the contact area of the grinding element 321 and the tooth surface of the gear G (shown by the dark-colored diagonal area in FIG. 4) will remain on the plane P where the axis of the grinding element 321 and the rotation axis A are located, and the additional installation angle γₐ of the gear G is defined as 0 at this time. However, as shown in FIGS. 3 and 4, by applying a one-time motion to the rotation axis A, an additional installation angle γₐ of the gear G can be increased. At this time, the gear G forms an axial rotational offset, and the position of the contact area of the grinding element 321 and the tooth surface of the gear G can be changed. By adjusting the additional installation angle γₐ of the gear G by the one-time motion, the contact area of the grinding element 321 and one side of the tooth surface of the gear G will shift downwards (as shown in the light-colored diagonal area in FIG. 4, but the contact area of the element 321 and the other side of the tooth surface of the gear G will shift upwards), so that the center O2 of the contact area is not on the plane P where the axis of the grinding element 321 and the rotation axis A applied the one-time motion are located. Accordingly, the tangential direction of the grinding element 321 during the grinding process is not parallel to the tooth groove direction of the gear G, thereby changing the direction of the grinding texture produced by the grinding element 321 on the tooth surface of the gear G.

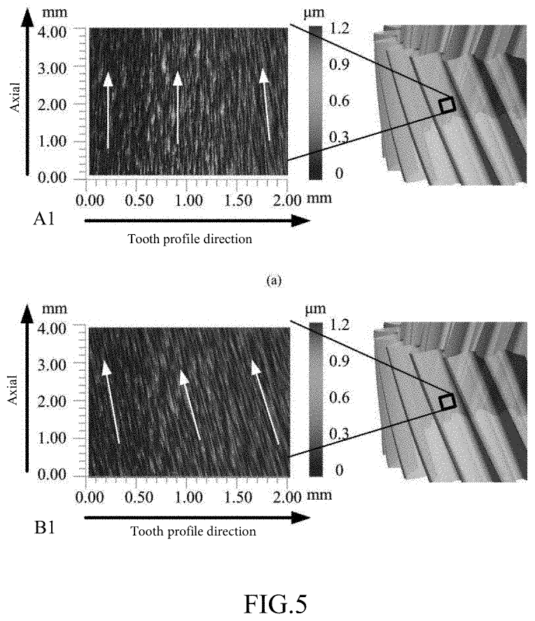

Please refer to FIG. 1 and FIG. 5 together. FIG. 5 is a schematic diagram of a comparison of the grinding results of the tooth surface of the gear of the control group A1 and the experimental group B1 of the gear processing device of the present disclosure. In the following experiment, the gear processing device 1 of the present disclosure is used to perform once grinding operation on the tooth surface of the gear of the same specification. The control group A1 was set under the condition that no additional motion was applied to the aforementioned rotating axis A. The experimental group B1 was set under the condition that a one-time motion was applied to the rotation axis A to increase the additional installation angle γₐ of the gear G by 1.5°. The image of the grinding result along the axial direction and the tooth profile direction of the gear after the grinding operation can be simulated and obtained. Wherein, the rotational speed of the worm grinding wheel is 6000 rpm, the feed rate of the axial direction of the workpiece gear is 500 mm/min, the helix angle is 25°, and the wheel radius of the worm grinding wheel is 200 mm.

As shown in FIG. 5, after analyzing the experimental simulation results, it can be seen that the grinding texture of the control group A1 is roughly straight grinding texture, while the grinding texture of the experimental group B1 is roughly oblique grinding texture. When the grinding texture is oblique grinding texture, it can effectively reduce the single-frequency noise caused by gear meshing. Accordingly, the experimental group B1 with one-time motion can produce better noise reduction effect than the control group A1.

In addition, when the additional installation angle γₐ is added to the gear G, it will cause the geometric deviation of the tooth surface of the gear G. Therefore, it is necessary to generate motion modified parameters for the additional motions of other axial directions through the worm grinding wheel dressing and gear grinding process to correct this deviation. The motion modified parameter here can be a function of constant, time or movement of other axis. Combining the aforementioned motion modified parameters with the original motion equations of each axis in the gear processing device of the present disclosure, the grinding control equation corresponding to each axis can be obtained, and then the grinding texture of the tooth surface of the gear can be calculated. The grinding control equation corresponding to each axis is as follow:

$$\{ \begin{matrix}{ψ}_{A} = {γ}_{wg} + {γ}_{a} \\ {F}_{X 1} ( {ψ}_{w} ) = {r}_{d} + {r}_{w} + {f}_{X 1} ( {ψ}_{w} ) \\ {F}_{Y 1} ( {ψ}_{w} ) = \pm {p}_{w} \frac{{ψ}_{w}}{2 π} + {f}_{Y 1} ( {ψ}_{w} ) \\ {ψ}_{A 1} ( {ψ}_{w} ) = {γ}_{dw} + {f}_{A 1} ( {ψ}_{w} ) \\ {F}_{X} ( {F}_{Z} ) = {r}_{w} + {r}_{g} + {xm}_{n} + {f}_{X} ( {F}_{Z} ) \\ {F}_{Y} ( {F}_{Z} ) = \frac{{b}_{w}}{{b}_{g}} {F}_{Z} + {f}_{Y} ( {F}_{Z} ) \\ {ψ}_{C} ( {ψ}_{B} , {F}_{Z} ) = \pm {ψ}_{B} \frac{{T}_{w}}{{T}_{g}} \frac{{b}_{w}}{{b}_{g}} \frac{{F}_{Z}}{{p}_{w}} + \frac{tan {β}_{g} {F}_{Z}}{{r}_{g}}\end{matrix}$$

Where ƒ is the modified motion function, and γₐ is the additional installation angle.

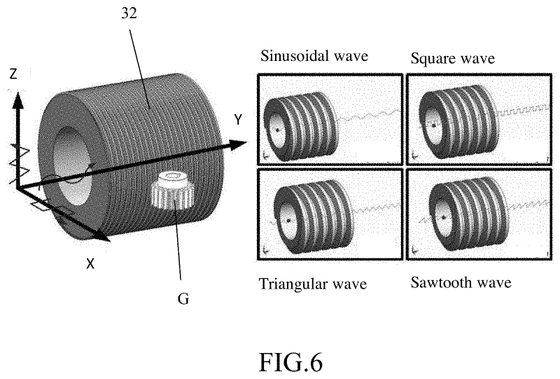

Reference is made to FIGS. 1 and 6 collectively, where FIG. 6 is a schematic diagram of the additional motion performed by the grinding unit of the gear processing device of the present disclosure. As shown in FIG. 6, in an embodiment of the present disclosure, the additional motion is a continuous and slight wave motion, and the wave motion is selected from at least one or a combination of the following groups: a sine wave motion, a square wave motion, a triangle wave motion or a sawtooth wave motion. Each wave motion has corresponding amplitude and frequency, and the amplitude or frequency of the wave motion can be adjusted according to different requirements.

In an embodiment of the present disclosure, the control unit 40 can control the driving unit 60 to apply the different wave motions to at least two of the plurality of second corresponding axial directions of the grinding assembly during the grinding process. For example, assuming that the plurality of second corresponding axial directions include the X axis and the Y axis, the control unit 40 can control the driving unit 60 to apply a square wave motion to the X axis and apply a sine wave motion to the Y axis. Furthermore, it is assumed that the plurality of second corresponding axial directions include X axis, Y axis, and Z axis. The control unit 40 can control the driving unit 60 to apply a square wave motion to the X axis, apply a sine wave motion to the Y axis, and apply a triangle wave motion to the Z axis, but the present disclosure is not limited thereto and may be changed according to different needs.

In an embodiment of the present disclosure, the control unit 40 can control the driving unit 60 to apply the same wave motions with different amplitudes or frequencies to at least two of the plurality of second corresponding axial directions of the grinding unit during the grinding process. For example, assuming that the plurality second corresponding axial directions include the X axis and the Y axis, the control unit 40 can control the driving unit 60 to apply a sine wave motion to both the X axis and the Y axis, but the amplitude of the sine wave motion applied to the X axis is 3.6 μm and the frequency of the sine wave motion applied to the X axis is 30 Hz, while the amplitude of the sine wave motion applied to the Y axis is 5.0 μm and the frequency of the sine wave motion applied to the Y axis is 30 Hz. However, the present disclosure is not limited thereto and may be changed according to different needs.

In an embodiment of the present disclosure, the wave motion equations corresponding to different wave motions applied to any axis is as follows:

$$\begin{matrix}\text{?} ( t ) = {a}_{1} sin ( {b}_{1} 2 π ft ) & ( 1 ) \\ \text{?} ( t ) = \frac{4 {a}_{2}}{π} \text{?} - \frac{1}{( i + 1 )} sin [ ( i + 1 ) {b}_{2} 2 π ft ] & ( 2 ) \\ \text{?} ( t ) = {a}_{3} \{ \text{?} \frac{1}{{( i + 4 )}^{2}} sin [ ( i + 4 ) \text{?} 2 πft ) ] + \text{?} \frac{- 1}{{( j + 4 )}^{2}} sin [ ( j + 4 ) \text{?} 2 π ft ) ] \} & ( 3 ) \\ \text{?} ( t ) = {a}_{4} \text{?} - \frac{2}{i π} sin ( {ib}_{4} 2 π ft ) \\ ( {n}_{2} = 20 , {n}_{3} = {n}_{4} = 50 , ω = 2 π f ) \\ \text{?} \text{indicates text missing or illegible when filed} & ( 4 )\end{matrix}$$

In the above equations, the subscripts 1 to 4 of v, a, b, and n represent a sine wave, a square wave, a triangle wave and a sawtooth wave respectively. That is to say, the equation (1) represents the equation for applying the sine wave motion, equation (2) represents the equation for applying the square wave motion, equation (3) represents the equation for applying the triangle wave motion, and equation (4) represents the equation for applying sawtooth wave motion. Wherein a and b respectively control the amplitude and the frequency of the waveform, ω is the rotation speed, t is the time, and f is the frequency. When the value of n is larger, the waveform is closer to the true shape.

By combining the above corresponding wave motion equation with the original motion equation of each axis in the gear processing device of the present disclosure, the grinding control equations corresponding to each axis can be obtained, and then roughness of the tooth surface and the shape of the grinding texture of the gear can be calculated.

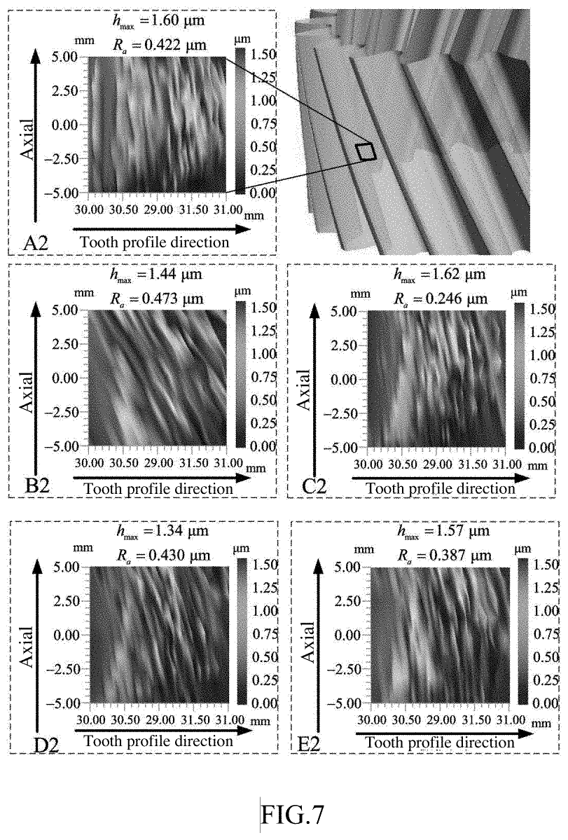

Please refer to FIGS. 1 and 7 together. FIG. 7 is a schematic diagram of a comparison of the grinding results of the tooth surface of the gear of the control group A2 and the experimental group B2˜E2 of the gear processing device of the present disclosure. In the following experiment, the gear processing device 1 of the present disclosure is used to perform once grinding operation on the tooth surface of the gear of the same specification. The control group A2 was set under the conditions that no wave motion was applied to the X axis, the Y axis and the Z axis. The experimental group B2 was set under the conditions that the sine wave motion was applied to the X axis, the Y axis and the Z axis. The experimental group C2 was set under the conditions that the square wave motion was applied to the X axis, the Y axis and the Z axis. The experimental group D2 was set under the conditions that the triangular wave motion was applied to the X axis, the Y axis and the Z axis. The experimental group E2 was set under the conditions that the sawtooth wave motion was applied to the X axis, the Y axis and the Z axis. The image of the grinding result along the axial direction and the tooth profile direction of the gear after the grinding operation, the maximum grinding texture depth of the tooth surface and the value of the tooth surface roughness can be simulated and obtained. Wherein, the frequencies of all wave motions to be applied are 30 Hz, the amplitudes of all wave motions applied to the X axis are 3.6 μm, and the amplitudes of all wave motions applied to the Y axis are 5.0 μm, and the amplitudes of all wave motions applied to the Z axis are 4.0 μm. The feed rate of the axial direction of the worm grinding wheel is 20 mm/s, the helix angle is 0°, the wheel radius of the worm grinding wheel is 200 mm, and the abrasive particle size of the worm grinding wheel is 470 μm.

As shown in FIG. 7, after analyzing the experimental simulation results, it can be seen that the grinding texture of the control group A2 is roughly straight, while the grinding texture of the experimental groups B2 and D2 is roughly staggered, while the grinding texture of the experimental groups C2 and E2 are roughly straight grinding texture similar to those of the control group A2. When the grinding texture is oblique grinding texture, it can effectively reduce the single-frequency noise caused by gear meshing. Accordingly, the experimental groups B2 and D2 that applied the sine wave motion can produce better noise reduction effects than the control group A2. However, the experimental groups C2 and E2 that applied the square wave motion did not achieve much improvement in the shape of the grinding texture of the tooth surface.

Then, in terms of the maximum grinding texture depth hₘₐₓ, the maximum grinding texture depth of the control group A2 is approximately 1.60 μm, the maximum grinding texture depth of the experimental group B2 is approximately 1.44 μm, the maximum grinding texture depth of the experimental group C2 is approximately 1.62 μm, the maximum grinding texture depth of the experimental group D2 is about 1.34 μm, and the maximum grinding texture depth of the experimental group E2 is about 1.57 μm. Compared with the control group A2, the maximum grinding texture depth of the experimental groups B2 and D2 decreased by about 16%, while the improvement for the grinding texture depth of the experimental groups C2 and E2 had been limited.

In terms of tooth surface roughness Rₐ, the tooth surface roughness of the control group A2 is about 0.422 μm, the tooth surface roughness of the experimental group B2 is about 0.473 μm, the tooth surface roughness of the experimental group C2 is about 0.246 μm, the tooth surface roughness of the experimental group D2 is about 0.430 μm, and the tooth surface roughness of the experimental group E2 is about 0.387 μm. Compared with the control group A2, the improvement effect for the value of the tooth surface roughness of the experimental group C2 is significantly better than the experimental group B2, D2 and E2.

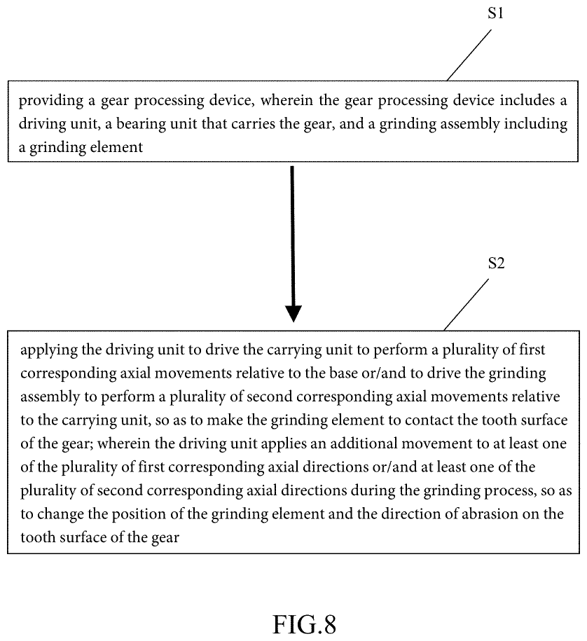

Reference is next made to FIG. 8, which is a flowchart of the gear processing method of the present disclosure. As shown in FIG. 8, the present disclosure further includes a gear processing method, which can be applied to the gear processing device of the present disclosure or other devices with similar functional characteristics. The gear processing method of the present disclosure includes the following steps:

Step S1: a gear processing device is provided. The gear processing device includes a driving unit, a bearing unit that carries the gear, and a grinding assembly, and the grinding assembly includes a grinding element.

Step S2: Utilize the driving unit to drive the bearing unit to perform a motion of a plurality of first corresponding axial directions relative to the base and drive the grinding assembly to perform a motion of a plurality of second corresponding axial directions relative to the bearing unit, so as to make the grinding element contacts the tooth surface of the gear; wherein the driving unit applies an additional motion to at least one of the plurality of first corresponding axial directions or/and at least one of the plurality of second corresponding axial directions during the grinding process, so as to change the direction of the grinding texture produced by the grinding element on the tooth surface of the gear.

In summary, the gear processing device and method of the present disclosure can change the shape, angle and depth of the grinding texture of the tooth surface of the gear by applying a small amount of additional motion to at least one of the plurality of axial directions when the bearing unit or/and the grinding assembly perform the motions of the plural axial directions to form different tooth surface roughness, thereby reducing the noise caused by vibration when the gear has meshed and improving the quality and efficiency of the processing gear.

In the above, the present disclosure based on the multi-directional multi-joint turning piece and display device have been described, but the present embodiment can be modified in various ways other than the above-mentioned embodiment as long as it does not deviate from its gist. The various embodiments and modifications described above can be implemented in an appropriate combination.

What is claimed is:

1. A gear processing device for performing a surface processing on a tooth surface of a gear, comprising:
a base;
a driving unit arranged on the base;
a bearing unit arranged on the base, wherein the bearing unit is used for bearing the gear, and the bearing unit is driven by the driving unit to perform a motion with a plurality of first corresponding axial directions relative to the base;
a grinding assembly arranged on the base, wherein the grinding assembly includes a grinding element, and the grinding assembly is driven by the driving unit to perform a motion with a plurality of second corresponding axial directions relative to the bearing unit, so that the grinding element contacts the tooth surface of the gear; and
a control unit electrically connected to the driving unit, wherein the control unit is used to control the driving unit to apply an additional motion to at least one of the plurality of first corresponding axial directions, or/and at least one of the plurality of second corresponding axial directions during a grinding process to change direction of the grinding texture produced by the grinding element on the tooth surface of the gear.

2. The gear processing device of claim 1, wherein the additional motion is a one-time motion or a continuous motion.

3. The gear processing device of claim 2, wherein an additional installation angle of the gear is adjusted by the one-time motion, so that a center of a contact area of the grinding element and the tooth surface of the gear is not on a plane where an axis of the grinding element and a rotation axis applied the one-time motion are located.

4. The gear processing device of claim 2, wherein the continuous motion is a wave motion.

5. The gear processing device of claim 4, wherein the wave motion is selected from at least one or a combination of the following groups: a sine wave motion, a square wave motion, a triangle wave motion, or a sawtooth wave motion.

6. The gear processing device of claim 5, wherein the control unit controls the driving unit to apply the different wave motions to at least two of the plurality of second corresponding axial directions during the grinding process.

7. The gear processing device of claim 5, wherein the control unit controls the driving unit to apply the same wave motions with different amplitudes or frequencies to at least two of the plurality of second corresponding axial directions during the grinding process.

8. The gear processing device of claim 1, wherein the grinding element is a grinding wheel.

9. The gear processing device of claim 1, wherein the plurality of first corresponding axial directions or the plurality of second corresponding axial directions are at least two selected from the following groups: three moving axes and three rotating axes corresponding to six degrees of freedom.

10. A gear processing method for performing a surface processing on a tooth surface of a gear, the gear processing method comprising:
providing a gear processing device, wherein the gear processing device includes a driving unit, a bearing unit that bears the gear, and a grinding assembly includes a grinding element; and
applying the driving unit to drive the bearing unit to perform a motion of a plurality of first corresponding axial directions relative to the base or/and to drive the grinding assembly to perform a motion of a plurality of second corresponding axial movements relative to the bearing unit, so as to make the grinding element to contact the tooth surface of the gear;
wherein the driving unit applies an additional motion to at least one of the plurality of first corresponding axial directions or/and at least one of the plurality of second corresponding axial directions during a grinding process, so as to change the direction of the grinding texture produced by the grinding element on the tooth surface of the gear.

11. The gear processing method of claim 10, wherein the additional motion is a one-time motion or a continuous motion.

12. The gear processing method of claim 11, wherein an additional installation angle of the gear is adjusted by the one-time motion, so that a center of a contact area of the grinding element and the tooth surface of the gear is not on a plane where an axis of the grinding element and a rotation axis applied the one-time motion are located.

13. The gear processing method of claim 11, wherein the continuous motion is a wave motion.

14. The gear processing method of claim 13, wherein the wave motion is selected from at least one or a combination of the following groups: a sine wave motion, a square wave motion, a triangle wave motion, or a sawtooth wave motion.

15. The gear processing method of claim 14, wherein the driving unit applies the different wave motions to at least two of the plurality of second corresponding axial directions during the grinding process.

16. The gear processing method of claim 14, wherein the driving unit applies the same wave motions with different amplitudes or frequencies to at least two of the plurality of second corresponding axial directions respectively during the grinding process.
